(19) United States
(12) Patent Application Publication
(10) Pub. No.: US 2014/0372285 A1
(43) Pub. Date: Dec. 18, 2014

(54) TRANSACTION TIME MONITORING

(71) Applicant: Bank of America Corporation, Charlotte, NC (US)

(72) Inventors: Matthew K. Bryant, Gastonia, NC (US); Devin D. Rhodes, Lexington, KY (US); Daryoosh Shirbabadi, Charlotte, NC (US)

(21) Appl. No.: 13/916,159

(22) Filed: Jun. 12, 2013

(51) Int. Cl. G06Q 20/38

(52) U.S. Cl. CPC G06Q 20/38
USPC 705/39

(57) ABSTRACT

To monitor transaction time, a first plurality of events is received. A transaction is associated with the first plurality of events. A time is determined for each event of the first plurality of events in the transaction to occur. An average time is calculated for a second plurality of events to occur based on the time of events in the first plurality of events. The second plurality of events is determined from a plurality of transactions and is based on one or more attributes, and the second plurality of events includes events from the first plurality of events. A standard deviation and a coefficient of variation are calculated for each event in the second plurality of events.

### TECHNICAL FIELD OF THE INVENTION

This invention relates generally to monitoring techniques, and more particularly to transaction time monitoring.

### BACKGROUND

Users interact with devices to perform any number of transactions. For example, a user may interact with an Automated Teller Machine (ATM) and/or an Automated Teller Assist (ATA) to withdraw money, cash a check, deposit a check, or perform an account inquiry. As another example, a user may interact with a laptop, a personal computer, a self-servicing device, or a smartphone to perform a transaction, such as purchase airline tickets, rent a car, interact with a hospitality business (e.g., self-registering for a hotel room), or obtain information regarding a financial account. For these transactions, it is difficult to understand the customer experience from an end-to-end transactional time length perspective.

### SUMMARY

According to embodiments of the present disclosure, disadvantages and problems associated with transaction time monitoring may be reduced or eliminated.

In certain embodiments, to monitor transaction time, a first plurality of events is received. A transaction is associated with the first plurality of events. A time is determined for each event of the first plurality of events in the transaction to occur. An average time is calculated for a second plurality of events to occur based on the time of events in the first plurality of events. The second plurality of events is determined from a plurality of transactions and is based on one or more attributes, and the second plurality of events includes events from the first plurality of events. A standard deviation and a coefficient of variation are calculated for each event in the second plurality of events.

Certain embodiments of the present disclosure may provide one or more technical advantages. A technical advantage of one embodiment includes determining the time it takes a user to complete a transaction. More specifically, each event that is performed during the transaction, by a device, a user, and/or the network, may be monitored from a timing perspective. By determining transaction times, enterprises may analyze the information to identify variations in transaction times as applications, interfaces, websites, software, firmware, devices, users, or other mechanisms are changed or updated. This quantification of event timing at the lower level also allows enterprises to determine a particular defect associated with the increase in transaction time and have development teams determine how to adjust the application, interface, website, software, firmware, device, or other mechanism to improve the transaction timing. Associates within an enterprise may analyze the variations in transaction times to provide additional updates or changes to improve a user's experience. Another technical advantage includes building models of previous transactions based on the retrieved transaction time information. Building models of transactions facilitates the development of applications, websites, software, devices, and other mechanisms. Understanding transaction information during the development phase may improve a user's transition to using updated or changed tools.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of a system for transaction time monitoring;

FIG. 2 illustrates an example flowchart for transaction time monitoring;

FIG. 3 illustrates an example screenshot including average times of events in a transaction; and

FIG. 4 illustrates an example screenshot including the coefficient of variation of different events in a transaction.

### DETAILED DESCRIPTION OF THE DRAWINGS

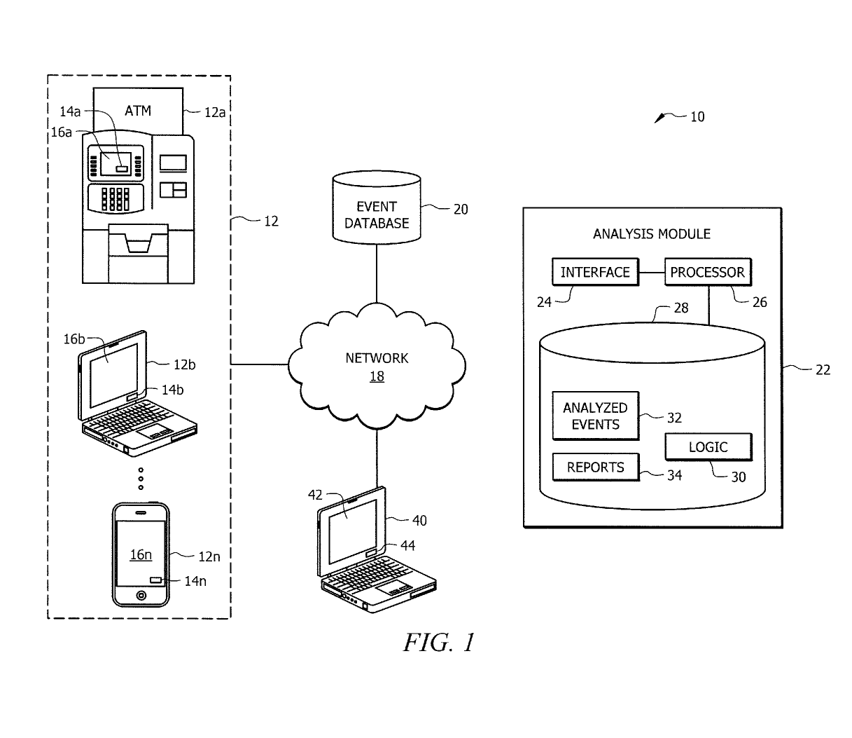

Embodiments of the present invention and its advantages are best understood by referring to FIGS. 1 through 4 of the drawings, like numerals being used for like and corresponding parts of the various drawings.

Users interact with devices to perform any number of transactions. For example, a user may interact with an Automated Teller Machine (ATM) and/or an Automated Teller Assist (ATA) to withdraw money, cash a check, deposit a check, or perform an account inquiry. As another example, a user may interact with a laptop, a personal computer, a self-servicing device, or a smartphone to perform a transaction, such as purchase airline tickets, rent a car, interact with a hospitality business (e.g., self-registering for a hotel room), or obtain information regarding a financial account. For these transactions, it is difficult to understand the customer experience from an end-to-end transactional time length perspective.

An enterprise that provides the application, interface, software, website, device, firmware, or other suitable mechanism for a user to interact with to perform the transaction has difficulty measuring the time associated with the transaction. Certain embodiments of the present disclosure provide a system and method for calculating the transaction time and providing further analysis of the transaction time to facilitate development and troubleshooting of the application, interface, software, website, device, firmware, or other suitable mechanism. The system and method disclosed provide a way to measure the times of all types of transactions that are performed on devices.

FIG. 1 illustrates a block diagram of a system for transaction time monitoring. System 10 includes devices 12 that a user interacts with to perform a transaction. The transaction includes a plurality of events that the user and system 10; including device 12, application 14, and network 18; perform to complete the transaction. Devices 12 communicate the events to event database 20 through network 18, and analysis module 22 performs calculations on the events to facilitate monitoring of the transaction and further analysis of the transaction.

System 10 includes devices 12a-12n, where n represents any suitable number, that allow a user to interact with an application 14 to complete a transaction. Device 12 communicates the events in a transaction to event database 20. A user may complete any suitable transaction using device 12. For example, a user may deposit a check, withdraw money, purchase products or services, obtain account information, or any other suitable transaction. To complete the transaction, the user interacts with application 14, and the user and system 10 perform various events to complete the transaction. In an embodiment, an event represents a unique transition between different steps in a transaction. For example, when a user attempts to deposit a check on device 12a, application 14 launches and communicates a screen to the user to enter a personal identification number (“PIN”); the user enters the PIN; application 14 communicates the entered information for authentication; if the PIN is authenticated, application 14 launches a subsequent screen for the user to enter the transaction to complete; the user determines to deposit a check; application 14 provides the accounts in which the check may be deposited; the user selects the account; and the events continue further until the transaction of depositing a check is complete. Device 12 may communicate the events to event database 20 while the user interacts with application 14, after a user concludes working with application 14, at a predetermined time, or at any other suitable time.

Examples of device 12 include a mobile phone, a personal digital assistant, a portable media player (e.g., portable video player, digital audio player, etc.), a laptop, a netbook, a Ultrabook™, a tablet, an ATM, a smart TV, or any other suitable device. Device 12 may be compatible with any suitable platform or operating system. For example, device 12 may include an Android™ device, an Apple® device, a Windows® device, a BlackBerry® device, or any other suitable device. Device 12 includes any necessary hardware and software suitable to carry out its functions. In an embodiment, device 12 includes a memory that stores events for communication to event database 20. Certain embodiments of device 12 include an application 14 and graphical user interface (GUI) 16.

Device 12 includes one or more applications 14. Application 14 represents any suitable software or logic that allows a user to access information, provides information to a user, and/or facilitates a user performing a transaction with an enterprise. For example, a user may launch application 14 on device 12, input login credentials into application 14, and gain access to a plurality of financial accounts serviced by the enterprise associated with application 14. The described embodiments contemplate communicating, to event database 20 and/or analysis module 22, the events involved in a transaction to facilitate monitoring the transaction time and determining variances in the transaction time. An administrator, the user of device 12, or any other suitable entity may change the configuration of application 14. Application 14 may include a native application or a hybrid application stored on mobile device 12.

In the illustrated embodiment, device 12 also includes a GUI 16 that displays information from application 14 to a user to facilitate a user performing a transaction using application 14. For example, GUI 16 may display a login screen for a user to provide login credentials to access information using application 14. GUI 16 is generally operable to tailor and filter data entered by and presented to the user. GUI 16 may provide the user with an efficient and user-friendly presentation of information using a plurality of displays having interactive fields, pull-down lists, and buttons operated by the user. GUI 16 may include multiple levels of abstraction including groupings and boundaries. It should be understood that the term GUI 16 may be used in the singular or in the plural to describe one or more GUIs 16 in each of the displays of a particular GUI 16.

Network 18 represents any suitable network operable to facilitate communication between the components of system 10, such as devices 12, event database 20, and analysis module 22. Network 18 may include any interconnecting system capable of transmitting audio, video, signals, data, messages, or any combination of the preceding. Network 18 may include all or a portion of a public switched telephone network (PSTN), a public or private data network, a LAN, a MAN, a WAN, a WWAN, a local, regional, or global communication or computer network, such as the Internet, a wireline or wireless network, an enterprise intranet, or any other suitable communication link, including combinations thereof, operable to facilitate communication between the components.

Event database 20 stores, either permanently or temporarily, data related to events in a transaction. For example, event database 22 includes various attributes about each event involved in a transaction, including, but not limited to, the time it takes for an event to occur, the event type, device 12 location, device 12 type, whether the user of system 10 performs the event, weather information, or any other suitable attribute. Event database 20 includes any one or a combination of volatile or non-volatile local or remote devices suitable for storing information. For example, event database 20 may include random access memory (RAM), read-only memory (ROM), magnetic storage devices, optical storage devices, or any other suitable information storage device or combination of these devices. In an embodiment, event database 20 represents a data source that provides information regarding the events to analysis module 22. Analysis module 22 may use the event information to analyze the events and the transactions.

Analysis module 22 represents any suitable component that analyzes event information from transactions to facilitate in project development, project troubleshooting, and/or subsequent modeling of the transactions. Analysis module 22 may include a network server, any suitable remote server, a mainframe, a host computer, a workstation, a web server, a personal computer, a file server, or any other suitable device operable to communicate with device 12 and/or event database 20. In some embodiments, analysis module 22 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of analysis module 22 may be performed by any suitable combination of one or more servers or other components at one or more locations. In the embodiment where analysis module 22 is a server, the server may be a private server, or the server may be a virtual or physical server. The server may include one or more servers at the same or remote locations. Also, analysis module 22 may include any suitable component that functions as a server. In the illustrated embodiment, analysis module 22 includes a network interface 24, a processor 26, and a memory 28.

Network interface 24 represents any suitable device operable to receive information from network 18, transmit information through network 18, perform processing of information, communicate with other devices, or any combination of the preceding. For example, network interface 24 receives event information associated with a transaction from event database 20 and/or device 12. Analysis module 22 may receive the event information at any suitable time. For example, analysis module 22 receives the information at a predetermined time every predetermined period, such as receiving the event information every day at 2:00 AM. As another example, network interface 24 receives the average time information associated with the events from event database 20 or some other suitable component, the number of times the event occurred in a given time period, and/or the standard deviation of the event. By receiving this information for each event, analysis module 22 is able to consider a broad set of information in the analysis and/or model previously occurring transactions. As another example, network interface 24 communicates the analyzed event information to computer 40 for additional analysis. Network interface 24 represents any port or connection, real or virtual, including any suitable hardware and/or software, including protocol conversion and data processing capabilities, to communicate through a LAN, WAN, or other communication system that allows analysis module 22 to exchange information with devices 12, network 18, event database 20, computer 40, or other components of system 10.

Processor 26 communicatively couples to network interface 24 and memory 28, and controls the operation and administration of analysis module 22 by processing information received from network interface 24 and memory 28. Processor 26 includes any hardware and/or software that operates to control and process information. For example, processor 26 executes logic 30 to control the operation of analysis module 22. Processor 26 may be a programmable logic device, a microcontroller, a microprocessor, any suitable processing device, or any suitable combination of the preceding.

Memory 28 stores, either permanently or temporarily, data, operational software, or other information for processor 26. Memory 28 includes any one or a combination of volatile or non-volatile local or remote devices suitable for storing information. For example, memory 26 may include RAM, ROM, magnetic storage devices, optical storage devices, or any other suitable information storage device or a combination of these devices. While illustrated as including a particular module, memory 28 may include any suitable information for use in the operation of analysis module 22. In the illustrated embodiment, memory 28 includes logic 30, analyzed events 32, and reports 34.

Logic 30 generally refers to rules, algorithms, code, tables, and/or other suitable instructions embodied in a computer-readable storage medium for performing the described functions and operations of analysis module 22. For example, logic 30 facilitates the determination of event information based on attributes and facilitates the calculations of variations in the time it takes to complete events. Logic 30 also facilitates the determination of whether additional analysis should occur regarding the events based on the time variation calculation.

Analyzed events 32 refer to events on which analysis module 22 has performed certain calculations. In an embodiment, analysis module 22 receives events from event database 20 and/or device 12 and calculates an average time for an event to occur across a plurality of transactions. Additionally, in this embodiment, analysis module 22 may consider certain attributes when determining which events to include in the calculation of average time. For example, analysis module 22 receives a plurality of events associated with a particular event type used in a particular transaction type, a particular event location, and a particular device on which the user performs the event. As a specific example, analysis module 22 receives a plurality of “transaction selection” events used in unassisted check deposit transactions. Analysis module 22 receives these events that occur at an ATM at Location A over a specific time period. Analysis module 22 may receive the time it takes for the event to occur from event database 20 and/or device 12; or analysis module 22 may receive a start time and end time of the event and may calculate the difference to determine the time it takes for the event to occur.

Analyzed events 32 may also include information regarding the latency of the different actors involved in the events. For example, latency in the transaction occurs because of actions performed by the system, such as the network and/or the device. As another example, latency occurs because of actions performed by humans. As yet another example, there may be latencies associated with transitions between certain events in a transaction. By taking a granular view of the transaction and analyzing each event, system 10 determines where the latencies arise and system 10 may be updated to decrease the latencies and improve the transaction time.

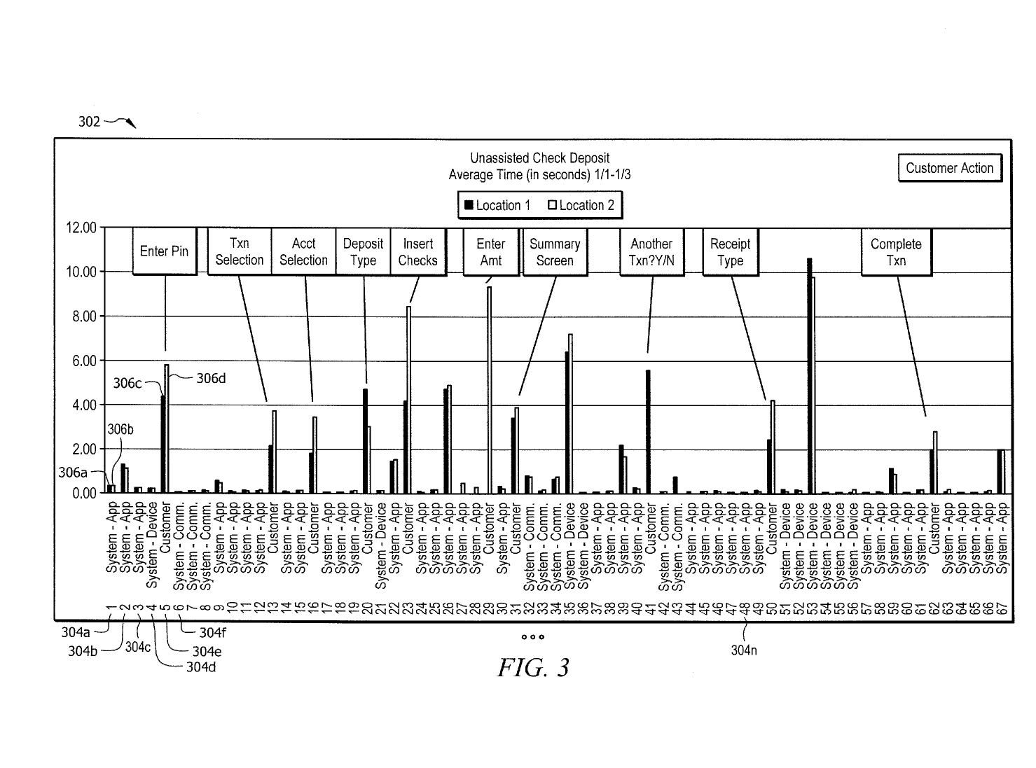

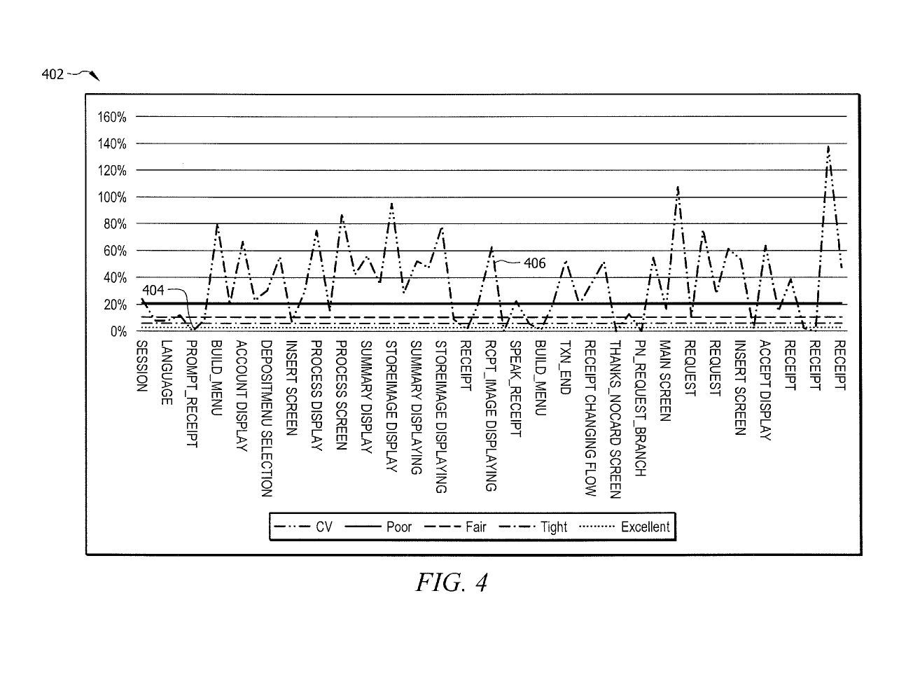

Reports 34 refer to the information prepared based on the analyzed events and calculations. Reports 34 may be compiled based on pre-configured rules or dynamic requests. For example, analysis module 22 may generate a bar graph of the average time it takes to complete the various events included in a transaction. FIG. 3 provides an exemplary graph that may be stored as report 34. As another example, analysis module 22 may generate a graph that indicates the coefficient of variation of the different events. FIG. 4 provides an exemplary plot that may be stored as report 34. In another embodiment, analysis module 22 generates reports 34 that indicate the latencies associated with the various actors, including, but not limited to, system latencies and human latencies.

Enterprise device 40 communicates with analysis module 22 to configure the events and/or transactions to analyze and to receive reports 34 of the analyzed information. Enterprise device 40 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. For example, enterprise device 40 may access application 44 to view and analyze reports 34.

In the illustrated embodiment, enterprise device 40 includes a GUI 42 that displays information received from analysis module 22. GUI 42 is generally operable to tailor and filter data entered by and presented to the user. GUI 42 may provide the user with an efficient and user-friendly presentation of information using a plurality of displays having interactive fields, pull-down lists, and buttons operated by the user. GUI 42 may include multiple levels of abstraction including groupings and boundaries. It should be understood that the term GUI 42 may be used in the singular or in the plural to describe one or more GUIs 42 in each of the displays of a particular GUI 42.

Enterprise device 40 also includes one or more applications 44. Application 44 represents any suitable software or logic that allows an associate to view, access, analyze, and/or process time information associated with events in a transaction. For example, application 44 may include a web application, a generic application, a routine application, a third-party application, a high-on-demand application, an application associated with a business unit, or any other future application types.

In an exemplary embodiment of operation, a user of device 12 interacts with application 14 to complete a transaction. To complete the transaction, a series of events occur. The user of device 12 performs some of the events and system 10, including device 12 and network 18, perform some of the events. For example, if the user attempts to obtain balance information by interacting with device 12n, the following events may be included in the balance inquiry transaction: obtain personal identification number, access accounts, receive account selection, and communicate account information to the user based on the account selection. Each of the events —obtain personal identification number, access accounts, receive account selection, and communicate account information—will take a certain amount of time to occur.

Event database 20 receives the event information and the time information from device 12. Event database 20 may receive the information during the transaction, at the end of a completed transaction, or at any other suitable pre-determined time. In an embodiment, device 12 may not communicate the event and time information to event database 20 until device 12 has a Wireless Fidelity (“WiFi”) connection.

After compilation of a certain number of events associated with a plurality of transactions or at a predetermined time, analysis module 22 retrieves event information. Analysis module 22 may receive the event information from event database 20 and/or device 12. The event information that analysis module 22 receives is associated with a plurality of similar transactions. For example, if four users conduct account inquiries on a certain day by interacting with device 12a, event database 20 stores the event information associated with each of the transactions, and analysis module 22 receives the event information associated with each of the transactions for analysis.

To conduct the analysis, analysis module 22 determines a time associated with each event and calculates the average time among the plurality of events based on attributes. For example, analysis module 22 calculates the average time associated with a plurality of same events in a particular transaction type that happen on a particular day at a particular device. The average time may be calculated based on any suitable unit of time, such as seconds or milliseconds. In an embodiment, analysis module 22 creates a report 34 that includes the average time of each event in the transaction. In another embodiment, analysis module 22 may compare average times of events according to different attributes. For example, analysis module 22 may compare the average times of events between a device 12 in Location A and a device 12 in Location B.

Based on the average time calculation, analysis module 22 calculates a standard deviation and coefficient of variation of each event. This calculation facilitates the determination of whether there is an unacceptable variation in the time it takes to complete events. In an embodiment, analysis module 22 generates report 34 that indicates the coefficient of variation of different events. If there is a variation in the timing of an event that is greater than a predetermined threshold, analysis module 22 generates a variation notification. For example, analysis module 22 may flag the event for additional analysis. Analysis module 22 communicates the variation notification to enterprise device 40.

In an embodiment, analysis module 22 determines latency information for each transaction. The latency of a transaction is based on the events and one or more attributes in the transaction. Analysis module 22 may store the events and associated latency.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may be used to perform any suitable analysis regarding transaction time. In an embodiment, system 10 facilitates the determination of event times for an associate at an enterprise to monitor and further analyze if variances occur. In another embodiment, system 10 facilitates the modeling of transactions by considering the event patterns that occur. For example, system 10 may identify event patterns that occur 80% of the time on a device 12 and model those event patterns to facilitate an understanding of transactional patterns in terms of time. Any suitable percentage can be defined to determine when to model the event patterns. As another example, analysis module 22 may calculate the average time, standard deviation, and coefficient of variation on any suitable number of events included in a transaction. As another example, system 10 may include any number of devices 12, networks 18, event databases 20, analysis module 22, and enterprise devices 40. Any suitable logic may perform the functions of system 10 and the components within system 10.

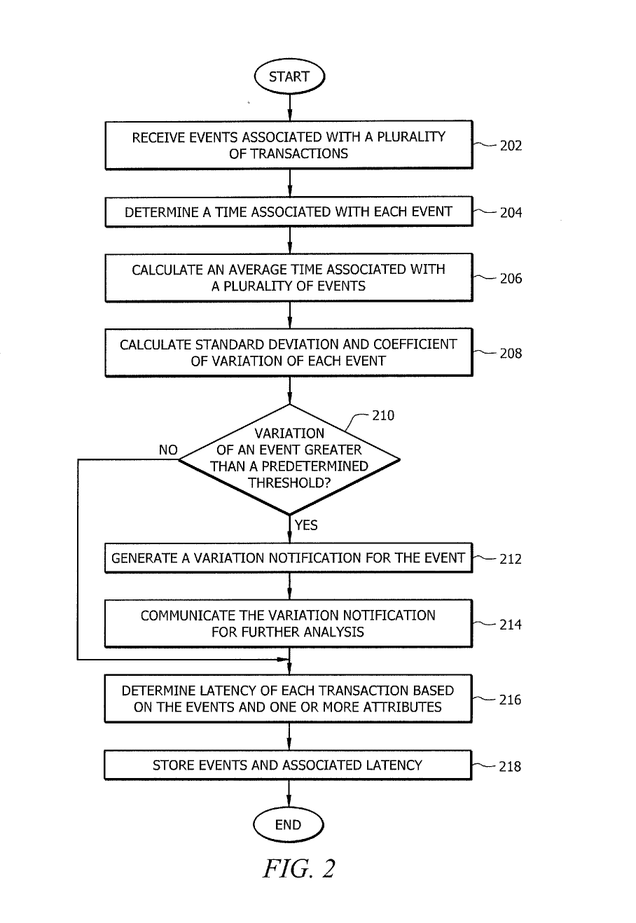

FIG. 2 illustrates an example flowchart for transaction time monitoring. At step 202, analysis module 22 receives events associated with a plurality of transactions. Analysis module 22 may receive the events from device 12 and/or event database 20. Analysis module 22 may receive each event in real time, at a pre-determined period time, on-demand, or at any suitable time. Analysis module 22 determines a time associated with each event at step 204. In an embodiment, the events communicated to analysis module 22 include a timestamp from which analysis module 22 determines the time it takes for an event to occur. As discussed above, a plurality of events occur during a transaction, and a certain amount of time elapses while each event occurs in completing the transaction.

At step 204, analysis module 22 calculates an average time associated with a plurality of events. Analysis module 22 may calculate the average time based on pre-defined attributes. For example, analysis module 22 may calculate the average time of an event based on an event type, an event location, day of an event, device type, software version, firmware version, weather information, or any other suitable attribute. Using the averages, analysis module 22 calculates the standard deviation and the coefficient of variation for each event to determine whether additional analysis is needed to address degraded performance; a defect in operation; an update or change in operation, software, hardware, and/or network characteristics; or any other occurrence that impacts the performance of an event. This will allow the enterprise to determine whether additional latency is being induced on the transaction and to determine the source of the latency. For example, when device 12 gets into a degraded state and starts to perform differently, for example, slower, the enterprise may identify the degraded device 12 and take action to improve performance or replace device 12. Through the analysis of the event variations, the enterprise may determine the cause of the degradation or defect, such as a bad processor, change in software version or firmware version, or any other suitable cause.

At step 210, analysis module 22 determines whether an event's variation is greater than a predetermined threshold. In an embodiment, an enterprise administrator sets a threshold for which an event's variation cannot exceed. If the variation exceeds this threshold, the method continues from step 212. Otherwise, the method proceeds to step 216.

If the variation is greater than the predetermined threshold at step 210, analysis module 22 generates a variation notification for the event at step 212. In an embodiment, the variation notification may include flagging the event. At step 214, analysis module 22 communicates the variation notification to enterprise device 40 for additional analysis of the event.

At step 216, analysis module 22 determines the latency of each transaction based on the events and one or more attributes. For example, analysis module 22 may determine the latency associated with different actors involved in the transaction and the actors impact on the timing of the transaction. Analysis module 22 stores the events and associated latency at step 218.

Modifications, additions, or omissions may be made to flowchart 200 depicted in FIG. 2. The method may include more, fewer, or other steps. For example, steps may be performed in parallel or in any suitable order. While discussed as analysis module 22 performing the steps, any suitable component of system 10 may perform one or more steps of the method.

FIG. 3 illustrates an example screenshot including average times of events in a transaction. Screenshot 300 represents one embodiment of a user interface in which a user views a report including average time information. The example screenshot 300 illustrates average event times in an unassisted check deposit transaction.

As discussed above, the average times of events may be determined based on various attributes. In the illustrated embodiment, the report includes information on events that occur during a particular time period, at two particular locations, and are associated with an unassisted check deposit transaction.

The illustrated screenshot 300 includes a bar graph 302 that provides a visual representation of the average times. The y-axis of bar graph 302 includes each event 304a-304n that occurs during the unassisted check deposit. The x-axis indicates the average time in seconds for an event to occur at each location.

For example, event 304a is an event performed by the system that involves the application. Bar 306a indicates the average time for the event to occur in Location 1 and bar 306b indicates the average time for the event to occur in Location 2. In the illustrated example, the average times for event 304a in Locations 1 and 2 is about the same.

As another example, event 304d represents an event performed by the customer when interacting with device 12. Event 304d represents a customer entering the personal identification number into the application. Bar 306c indicates the average time for the event to occur in Location 1, and bar 306d indicates the average time for the event to occur in Location 2. In the illustrated example, the average time for the event to occur in Location 1 is a little lower than the average time in Location 2.

The information presented in screenshot 300 allows an associate to analyze the timing of certain events and to determine whether certain events require additional analysis. Based on the information in bar graph 302, an associate may perform additional calculations on the data.

Modifications, additions, or omissions may be made to screenshot 300. For example, bar graph 302 may provide average times for events occurring in any suitable transaction. As another example, screenshot 300 may include the graphical representation of average times in any suitable form, such as in a plot, a line graph, a pie chart, or any other suitable representation.

FIG. 4 illustrates an example screenshot including the coefficient of variation of different events in a transaction. Screenshot 400 represents one embodiment of a user interface in which a user views a report including event variance information. The example screenshot 400 illustrates coefficient of variation information for a particular transaction.

As discussed above, the coefficient of variation may be determined based on the calculated event time averages. In the illustrated embodiment, screenshot 400 indicates the variation of each event in a transaction as a percentage. Also shown on screenshot 400 is the relative rating of the variation. For example, the variation may rate as poor, fair, tight, or excellent. Any other suitable ratings may be used to characterize the variations.

Position 404 illustrates the variation of an event for prompting a receipt. As illustrated, the variation for this event is near 0% and has an Excellent rating. Position 406 illustrates the variation of an event for displaying a receipt image. As shown, the variation for this event is near 60%, which is a Poor rating. Accordingly, this event may be flagged for additional analysis to determine what corrective action can be taken to improve the performance and decrease variability and transaction time.

Modifications, additions, or omissions may be made to screenshot 400. For example, screenshot may provide coefficients of variations for events occurring in any suitable transaction. As another example, screenshot 400 may include the graphical representation of average times in any suitable form, such as in a plot, a line graph, a pie chart, or any other suitable representation.

Certain embodiments of the present disclosure may provide one or more technical advantages. A technical advantage of one embodiment includes determining the time it takes a user to complete a transaction. More specifically, each event that is performed during the transaction, by a device, a user, and/or the network, may be monitored from a timing perspective. By determining transaction times, enterprises may analyze the information to identify variations in transaction times as applications, interfaces, websites, software, devices, or other mechanisms are changed or updated. This quantification of event timing at the lower level also allows enterprises to determine a particular defect associated with the increase in transaction time and have development teams determine how to adjust the application, interface, website, software, firmware, device, or other mechanism to improve the transaction timing. Associates within an enterprise may analyze the variations in transaction times to provide additional updates or changes to improve a user's experience. Another technical advantage includes building models of previous transactions based on the retrieved transaction time information. Building models of transactions facilitates the development of applications, websites, software, firmware, devices, and other mechanisms. Understanding transaction information during the development phase may improve a user's transition to using updated or changed tools.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus, comprising:
a network interface operable to receive a first plurality of events, wherein a transaction is associated with the first plurality of events;
a processor communicatively coupled to the network interface, the processor is operable to:
determine a time for each event of the first plurality of events in the transaction to occur;
calculate an average time for a second plurality of events to occur based on the time of events in the first plurality of events, wherein the second plurality of events is determined from a plurality of transactions and is based on one or more attributes and the second plurality of events includes events from the first plurality of events; and
calculate a standard deviation and a coefficient of variation for each event in the second plurality of events.

2. The apparatus of claim 1, wherein the processor is further operable to:
determine, according to the coefficient of variation, whether each event in the second plurality of events is greater than a predetermined threshold;
generate a variation notification for each event that is greater than the predetermined threshold.

3. The apparatus of claim 1, wherein the one or more attributes comprises at least one of the following: an event type, an event location, a day of an event, software type, firmware type, and a device implementing an event.

4. The apparatus of claim 1, wherein the processor is further operable to determine a latency of each transaction based on the second plurality of events.

5. The apparatus of claim 4, wherein determining the latency of each transaction comprises:
determining the latency of system events associated with the transaction; and
determining the latency of customer events associated with the transaction.

6. The apparatus of claim 1, wherein the processor is further operable to create a report identifying at least one of the following of the second plurality of events: the average time, the standard deviation, the coefficient of variation, and the latency.

7. The apparatus of claim 1, wherein the transaction, the first plurality of events, and the second plurality of events are associated with a selected one of an Automated Teller Machine, an Automated Teller Assist, and a self-service device.

8. Non-transitory computer readable medium comprising logic, the logic, when executed by a processor, operable to:
receive a first plurality of events, wherein a transaction is associated with the first plurality of events;
determine a time for each event of the first plurality of events in the transaction to occur;
calculate an average time for a second plurality of events to occur based on the time of events in the first plurality of events, wherein the second plurality of events is determined from a plurality of transactions and is based on one or more attributes and the second plurality of events includes events from the first plurality of events;
calculate a standard deviation and a coefficient of variation for each event in the second plurality of events.

9. The computer readable medium of claim 8, wherein the logic is further operable to:
determine, according to the coefficient of variation, whether each event in the second plurality of events is greater than a predetermined threshold;
generate a variation notification for each event that is greater than the predetermined threshold.

10. The computer readable medium of claim 8, wherein the one or more attributes comprises at least one of the following: an event type, an event location, a day of an event, software type, firmware type, and a device implementing an event.

11. The computer readable medium of claim 8, wherein the logic is further operable to determine a latency of each transaction based on the second plurality of events.

12. The computer readable medium of claim 11, wherein determining the latency of each transaction comprises:
determining the latency of system events associated with the transaction; and
determining the latency of customer events associated with the transaction.

13. The computer readable medium of claim 8, wherein the logic is further operable to create a report identifying at least one of the following of the second plurality of events: the average time, the standard deviation, the coefficient of variation, and the latency.

14. A method, comprising:
receiving a first plurality of events, wherein a transaction is associated with the first plurality of events;
determining, by a processor, a time for each event of the first plurality of events in the transaction to occur;
calculating, by the processor, an average time for a second plurality of events to occur based on the time of events in the first plurality of events, wherein the second plurality of events is determined from a plurality of transactions and is based on one or more attributes and the second plurality of events includes events from the first plurality of events;
calculating, by the processor, a standard deviation and a coefficient of variation for each event in the second plurality of events.

15. The method of claim 14, further comprising:
determining, according to the coefficient of variation, whether each event in the second plurality of events is greater than a predetermined threshold;
generating a variation notification for each event that is greater than the predetermined threshold.

16. The method of claim 14, wherein the one or more attributes comprises at least one of the following: an event type, an event location, a day of an event, software type, firmware type, and a device implementing an event.

17. The method of claim 14, further comprising determining, by the processor, a latency of each transaction based on the second plurality of events.

18. The method of claim 17, wherein determining the latency of each transaction comprises:
determining the latency of system events associated with the transaction; and
determining the latency of customer events associated with the transaction.

19. The method of claim 14, further comprising creating a report identifying at least one of the following of the second plurality of events: the average time, the standard deviation, the coefficient of variation, and the latency.

20. The method of claim 14, wherein the transaction, the first plurality of events, and the second plurality of events are associated with a selected one of an Automated Teller Machine, an Automated Teller Assist, and a self-service device.
